(19) United States
(12) Patent Application Publication
(10) Pub. No.: US 2007/0226542 A1
(43) Pub. Date: Sep. 27, 2007

(54) Simulated message generation for simulation testing of a node operation

(75) Inventors: Ralph T. Beeston, Tucson, AZ (US); Joseph W. Dain, Tucson, AZ (US)

Correspondence Address: Frank C. Nicholas;CARDINAL LAW GROUP, Suite 2000, 1603 Orrington Avenue, Evanston, IL, 60201, US

(73) Assignee: International Business Machines Corporation, Armonk, NY (US)

(21) Appl. No.: 11/388,407

(22) Filed: Mar. 24, 2006

(51) Int. Cl. G06F 11/00

(52) U.S. Cl. 714/33

(57) ABSTRACT

In a distributed data processing domain including a plurality of data processing nodes, a simulation data processing node is operated as a participant in a simulation testing of a node operation to determine a simulation job and a simulation command responsive to the simulation testing of the node operation. The simulation job is indicative of one or more actions to be performed by the simulation data processing node as a function of the simulation testing of the node operation, and the simulation command is indicative of a message format for a simulated message representative of simulation job, whereby the simulation data processing node builds the simulated message based on the simulation job and the simulation command.

### FIELD OF THE INVENTION

The present invention generally relates to an execution of a node operation within a domain. The present invention specifically relates to simulation testing of software/firmware for implementing an execution of the node operation.

### BACKGROUND OF THE INVENTION

A distributed data processing domain may consist of a system of multiple data processing nodes having components that communicate across physically separate boundaries using distributed queuing. For example, each data processing node may include an interface having a request message queue and a reply message queue that are respectively used by one of data processing nodes to request an execution of a node operation by one of the remaining data processing nodes and to receive reply messages from that data processing node indicating the outcome of the execution of the node operation.

One current simulation testing technique of a node operation provides users with a method for creating scenarios necessary for testing code for implementing the node operation. However, this current simulation testing technique has many drawbacks when applied to a distributed data processing domain.

First, the current simulation testing technique is not very efficient, because users do not have the ability to easily create scenarios necessary for testing. Consider, for example, a scenario where a mount is attempted to a drive that is already mounted. In order to create this scenario and generate the desired response using the existing simulation testing technique, a user must write a test case that mounts a drive and then attempts to mount the same drive again. This technique works, but as testing scenarios become more complex, it becomes more difficult for users to write the appropriate sequence of events in a test case necessary to generate the desired response from the simulation test. Clearly, there is a need for a better solution that entails allowing users to bypass the need for creating elaborate and complex test cases to generate a desired message from the simulation test.

### SUMMARY OF THE INVENTION

In a distributed data processing domain including a plurality of data processing nodes, the present invention provides a new and unique simulation data processing node that is operated as a participant in a simulation testing of a node operation.

One form of the present invention is a method of operating the simulation data processing node involving a determination by the simulation data processing node of a simulation job and a simulation command responsive to the simulation testing of the node operation, wherein the simulation job is indicative of one or more actions to be performed by the simulation data processing node as a function of the simulation testing of the node operation and wherein the simulation command is indicative of a message format for a simulated message representative of the simulation job. The method further involves a building by the simulation data processing node of the simulated message based on the simulation job and the simulation command.

A second form of the present invention is the simulation data processing node comprising a processor and a memory operable with the processor for executing instructions for participating in the simulation testing of the node operation. The instructions are executed for a determination by the simulation data processing node of a simulation job and a simulation command responsive to the simulation testing of the node operation, wherein the simulation job is indicative of one or more actions to be performed by the simulation data processing node as a function of the simulation testing of the node operation and wherein the simulation command is indicative of a message format for a simulated message representative of the simulation job. The instructions are further executed for a building by the simulation data processing node of the simulated message based on the simulation job and the simulation command.

A third form of the present invention is the simulation data processing node comprising a simulation job queue, a simulation command queue and a simulated message generator. The simulation job queue includes a simulation job indicative of one or more actions to be performed by the simulated message generator as a function of the simulation testing of the node operation. The simulation command queue includes a simulation command indicative of a message format for a simulated message representative of the simulation job. The simulated message generator is operable to determine the simulation job and simulation command as being responsive to the simulation testing of the node operation and to build the simulated message based on the simulation job and the simulation command.

The aforementioned forms and additional forms as wells as objects and advantages of the present invention will become further apparent from the following detailed description of the various embodiments of the present invention read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 illustrates one embodiment of distributed data processing domain in accordance with the present invention;

FIG. 2 illustrates one embodiment of a simulation job queue in accordance with the present invention;

FIG. 3 illustrates one embodiment of a simulation command queue in accordance with the present invention;

FIG. 4 illustrates a flowchart representative of one embodiment of a simulated message generation method in accordance with the present invention;

FIG. 5 illustrates one embodiment of a simulation data processing node in accordance with the present invention;

FIGS. 6 and 7 illustrate a flowchart representative of one embodiment of a requester simulation testing mode method in accordance with the present invention;

FIG. 8 illustrates an exemplary execution of the flowchart illustrated in FIGS. 6 and 7;

FIG. 9 illustrates a flowchart representative of a one embodiment of target simulation testing mode method in accordance with the present invention; and

FIG. 10 illustrates an exemplary execution of the flowchart illustrated in FIG. 9.

### DETAILED DESCRIPTION OF THE PRESENT INVENTION

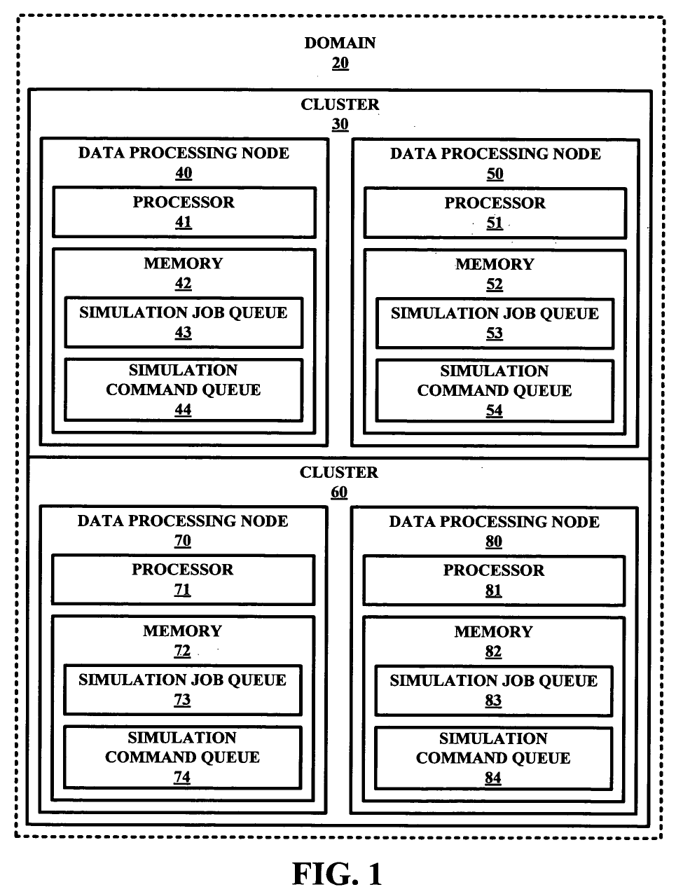

FIG. 1 illustrates a distributed data processing domain 20 employing a cluster 30 and a cluster 60. Cluster 30 includes a data processing node 40 having a processor 41 and a memory 42, and a data processing node 50 having a processor 51 and a memory 52. Cluster 60 includes a data processing node 70 having a processor 71 and a memory 72, and a data processing node 80 having a processor 81 and a memory 82.

A simulation testing of a node operation within domain 20 is in the form of a requester simulation testing mode or a target simulation testing mode. In the requester simulation testing mode, one of the data processing nodes 40, 50, 70 and 80 serves as a simulation data processing node for simulating a request for an execution of a node operation by one of the remaining data processing node 40, 50, 70 and 80 serving as a target data processing node. In the target simulation testing mode, one of the data processing nodes 40, 50, 70 and 80 serves as a simulation data processing node for simulating an execution of a node operation as requested by of the remaining data processing node 40, 50, 70 and 80 serving as a requester data processing node. Please note that the terms “simulation”, “requester” and “target” as used herein in conjunction with the term “data processing node” are only intended to facilitate an identification of the operational role of each data processing node during a simulation testing of a node operation and therefore should not be used to unduly limit or restrict the definition of data processing node as known in the art.

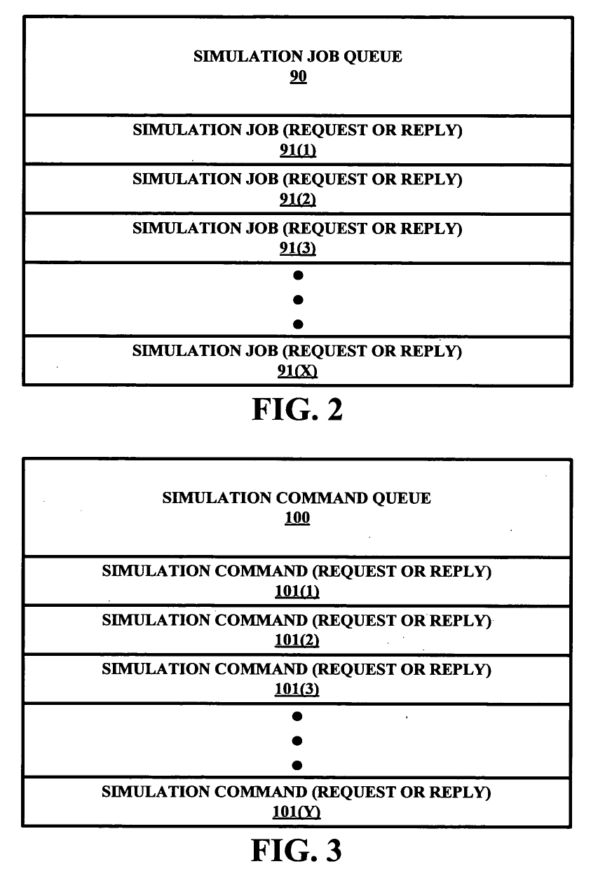

For selectively participating as a simulation data processing node during a simulation testing of a node operation, each memory 42, 52, 72 and 82 includes a respective simulation job queue 43, 53, 73 and 83 for storing one or more simulation jobs where each simulation job is indicative of one or more actions to be performed by the simulation data processing node during the simulation testing of a particular node operation. In one embodiment, as illustrated in FIG. 2, simulation job queues 43, 53, 73 and 83 are structurally configured in accordance with a simulation job queue 90 storing up to a X number of simulation jobs 91, where X≧1. Each simulation job 91 is associated with either the requester simulation testing mode or the target simulation testing mode.

Specifically, a simulation job 91 associated with the requester simulation testing mode is indicative of one or more request actions to be performed by the corresponding simulation data processing node in a simulation of a request for an execution of the node operation by a target data processing node. Conversely, a simulation job 91 associated with the target simulation testing mode is indicative of one or more reply actions to be performed by the corresponding simulation data processing node in a simulation of an execution of the node operation as requested by a target data processing node.

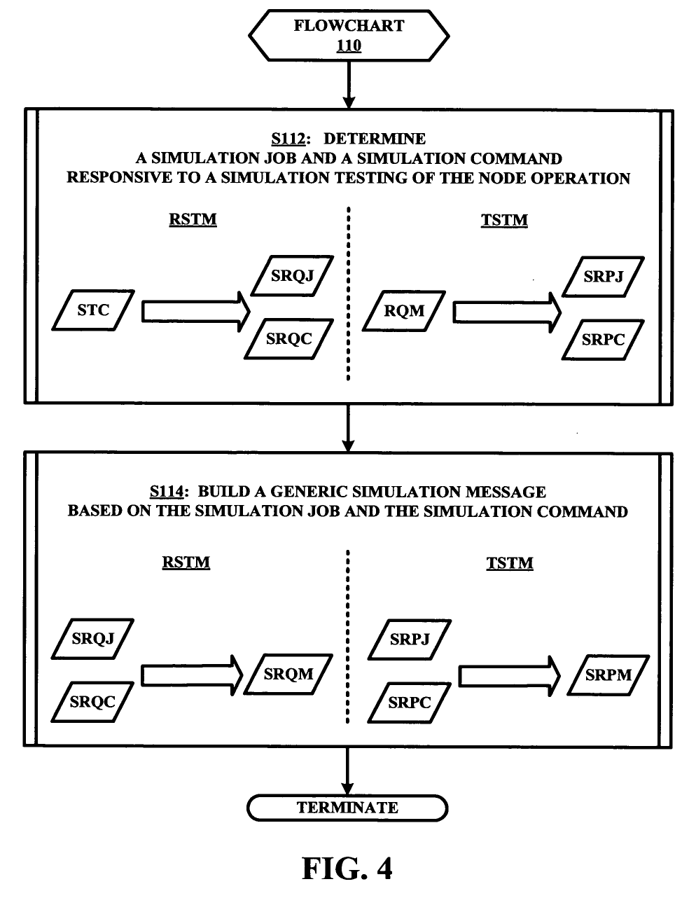

For selectively participating as a simulation data processing node during a simulation testing of a node operation, each memory 42, 52, 72 and 82 further includes a respective simulation command queue 44, 54, 74 and 84 for storing one or more simulation commands where each simulation command is indicative of a message format for a simulated message representative of one or more of simulation jobs. In one embodiment, as illustrated in FIG. 3, simulation command queues 44, 54, 74 and 84 are structurally configured in accordance with a simulation command queue 100 storing up to a Y number of simulation commands 101, where Y≧1. As with the simulation jobs 91 (FIG. 2), each simulation command job 101 is associated with either the requester simulation testing mode or the target simulation testing mode.

Specifically, a simulation command 101 associated with the requester simulation testing mode is indicative of a request message format for a simulated request message representative of one or more of simulation jobs 91 associated with the requester simulation testing mode. Conversely, a simulation command 101 associated with the target simulation testing mode is indicative of a reply message format for a simulated reply message representative of one or more of simulation jobs 91 associated with the target simulation testing mode.

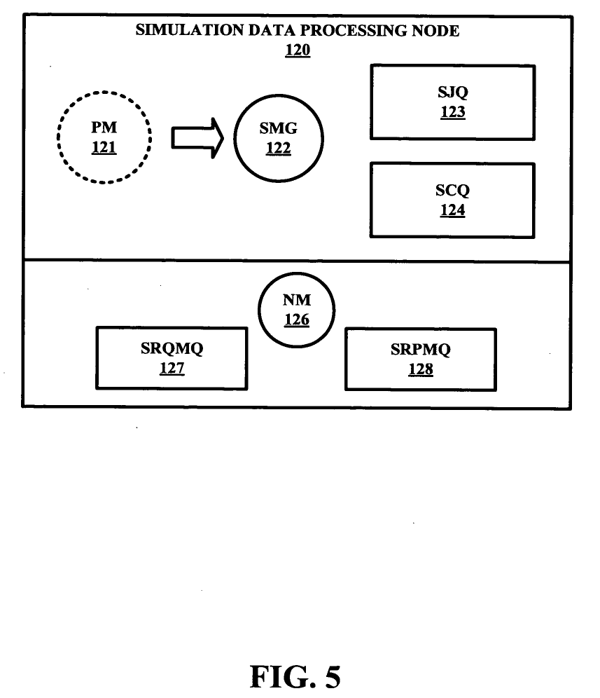

FIG. 4 illustrates a flowchart 90 representative of a simulated message generation method of the present invention, which is premised on a data processing node serving as a simulation data processing node during a simulation testing of a node operation in either a requester simulation testing mode or a target simulation testing mode.

Referring to FIG. 4, a stage S112 of flowchart 110 encompasses the simulation data processing node determining a simulation job and a simulation command responsive to the simulation testing of the node operation. In the requester simulation testing mode (“RSTM”) as shown in stage S112, the simulation data processing node determines a simulation request job SRQJ and a simulation command SRQC based on a simulation testing call STC to perform one or more request actions for simulating a request for an execution of the node operation by a target data processing node. In the target simulation testing mode (“TSTM”) as shown in stage S112, the simulation data processing node determines a simulation reply job SRPJ and a simulation reply command SRPC based on a request message RQM from a requester data processing node for requesting a simulation of an execution of the node operation by the simulation data processing node.

Upon a completion of stage S112, the simulation data processing node proceeds to a stage S114 of flowchart 110 to build a simulated message based on the simulation job and the simulation command determined during stage S112. In the requester simulation testing mode (“RSTM”) as shown in stage S114, the simulation data processing node builds a simulated request message SRQM based on the simulation request job SRQJ and the simulation request command SRQC determined during stage S112. In the target simulation testing mode as shown in stage S112, the simulation data processing node builds a simulated reply message SRPM based on the simulation reply job SRPJ and the simulation reply command SRPJ determined during stage S112.

In practice, the present invention does not impose any limitations or restrictions of a structural configuration of data processing nodes for implementing the simulated message generation method of the present invention as represented by flowchart 110 (FIG. 4).

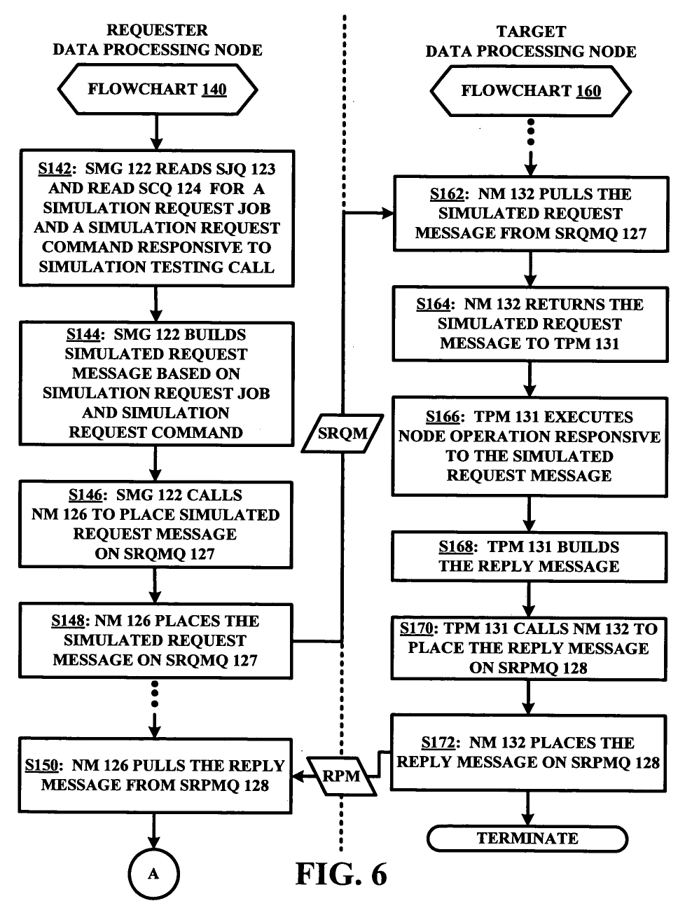

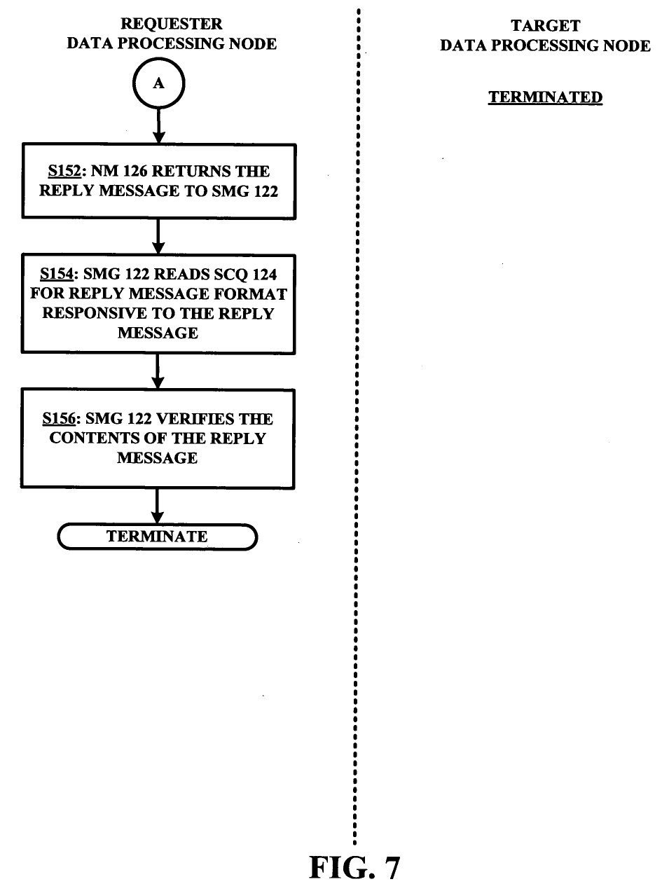

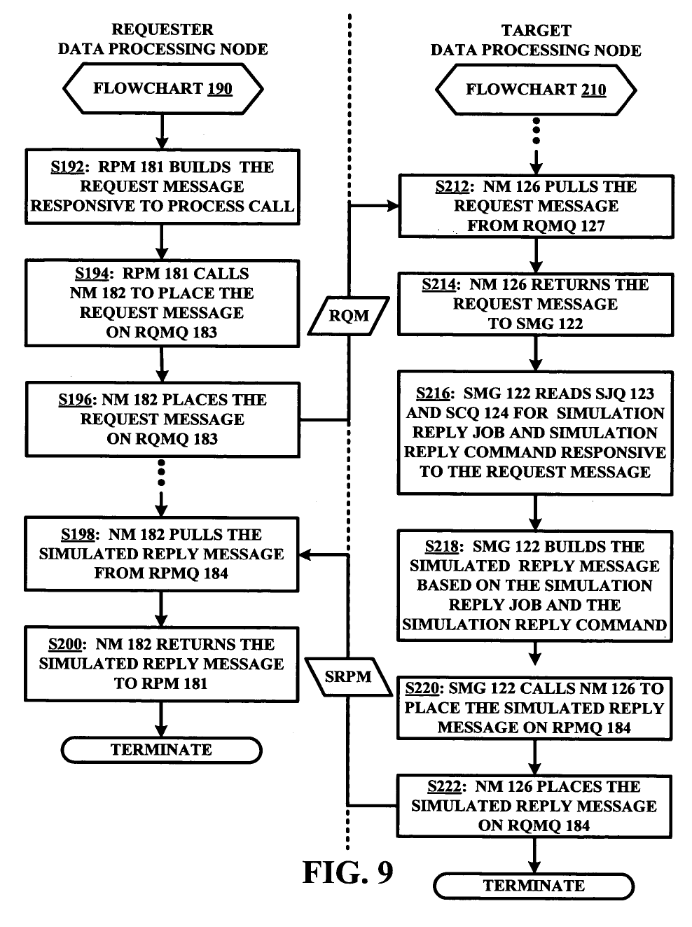

FIG. 5 illustrates an exemplary structural configuration of a simulation data processing node 120 suitable for data processing nodes 40, 50, 70 and 80 (FIG. 1). For simulation testing purposes of a node operation, simulation data processing node 120 employs a simulated message generator 122 in lieu of a processing module 121 structurally configured to implement the node operation as a requester and/or a target. To this end, simulated message generator 122 is a software/firmware daemon structurally configured to utilize a simulation job queue (“SJQ”) 123 and a simulation command queue (“SCQ”) 124 in executing a requester simulation testing mode method of the present invention as represented by a flowchart 140 illustrated in FIGS. 6 and 7, and in executing a target simulation testing mode method of the present invention as represented by a flowchart 190 illustrated in FIG. 9.

For supporting the interfacing of messages between simulation data processing node 120 and another data processing node, simulation data processing node 120 further employs a node messenger software/firmware module (“NM”) 126, a simulated request message queue (“SRQMQ”) 127 and a simulated reply message queue (“SRPMQ”) 128.

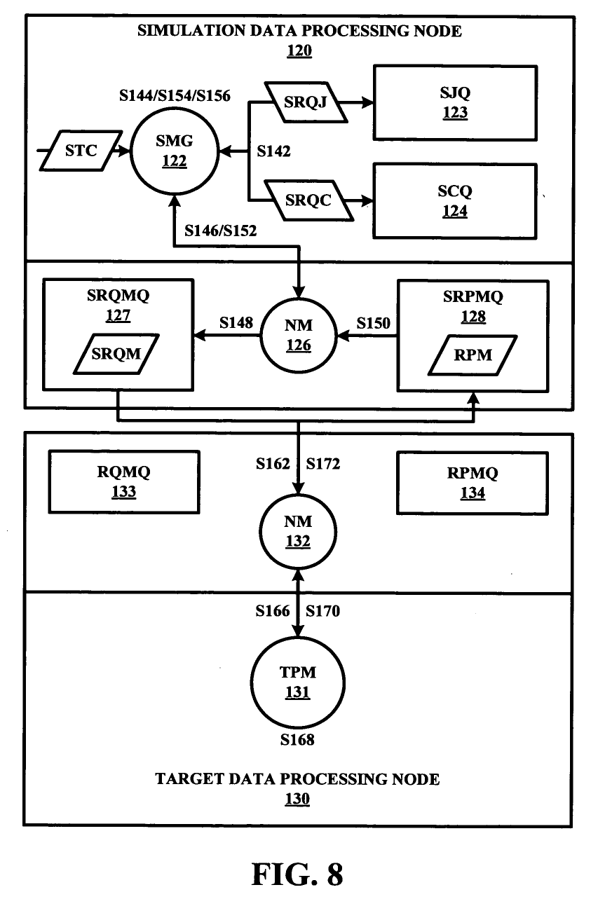

To facilitate an understanding of the requester simulation testing mode method of the present invention, the subsequent description of flowchart 140 is based on a concurrent implementation by a target data processing node 130 shown in FIG. 8 of a target processing method represented by a flowchart 160 illustrated in FIG. 6.

Referring to FIG. 6, a stage S142 of flowchart 140 encompasses simulated message generator 122 reading simulation job queue 123 and simulation command queue 124 for a simulation request job SRQJ and a simulation request command SRQC responsive to a simulation testing call STC for a simulation of a request for an execution of a node operation by target data processing node 130 as shown in FIG. 8.

A stage S144 of flowchart 140 encompasses simulated message generator 122 building a simulated request message SRQM based on simulation request job SRQJ and a simulation request command SRQC.

A stage S146 of flowchart 140 encompasses simulated message generator 122 calling node messenger 126 to place simulated request message SRQM on simulated request message queue 127 and a stage S148 of flowchart 140 encompasses node messenger 126 placing simulated request message SRQM on simulated request message queue 127 as shown in FIG. 8.

A stage S162 of flowchart 160 encompasses a node messenger 132 pulling simulated request message SRQM from simulated request message queue 127 in accordance with a polling scheme represented by a dashed portion of the arrow leading into stage S162.

A stage S164 of flowchart 160 encompasses node messenger 132 returning simulated request message SRQM to a target process module (“TPM”) 131 whereby target process module 131 during a stage S166 of flowchart 160 executes a node operation responsive to simulated request message SRQM to thereby build a reply message RPM during a stage S168 of flowchart 160 that is indicative of an outcome of the execution of the node operation by target process module 131.

A stage S170 of flowchart 160 encompasses target process module 131 calling node messenger 132 to place reply message RPM on simulated reply message queue 128 and a stage S172 of flowchart 160 encompasses node messenger 132 placing reply message RPM on simulated request message queue 128 as shown in FIG. 8.

A stage S150 of flowchart 140 encompasses node messenger 126 pulling reply message RPM from simulated reply message queue 128 in accordance with a polling scheme represented by a dashed portion of the arrow leading into stage S150.

A stage S152 of flowchart 140 encompasses node messenger 126 returning reply message RPM to simulated message generator 122 whereby simulated message generator 122 during a stage S154 of flowchart 150 reads simulation command queue 124 for a reply message format associated with reply message RPM to thereby verify the contents of reply message RPM during a stage S156 of flowchart 150.

Referring to FIG. 8, upon termination of flowchart 140, those having ordinary skill in the art will appreciate the generic, transparent and effective manner by which simulated request message SRQM was generated by simulation data processing node 120 and communicated to the target processing module 130 to thereby trigger an authentic execution of the subject node operation by target data processing module 130 that produces verifiable results via reply message RPM.

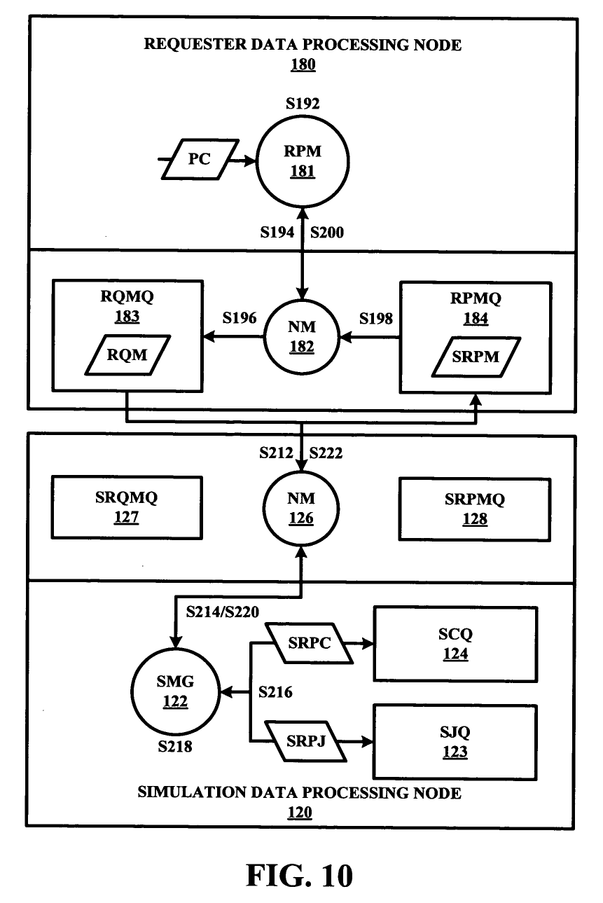

To facilitate an understanding of the target simulation testing mode method of the present invention, the subsequent description of flowchart 210 is based on a concurrent implementation by a requester data processing node 180 shown in FIG. 10 of a requester processing method represented by a flowchart 190 illustrated in FIG. 9.

Referring to FIG. 9, a stage S192 of flowchart 190 encompasses a request process module 181 building a request message RQM that is responsive to a process call from requester data processing node 180.

A stage S194 of flowchart 190 encompasses requester process module 181 calling a node messenger 182 to place request message RQM on a request message queue 183 and a stage S196 of flowchart 190 encompasses node messenger 182 placing request message RQM on request message queue 183 as shown in FIG. 10.

A stage S212 of flowchart 210 encompasses node messenger 126 pulling request message RQM from request message queue 183 in accordance with a polling scheme represented by a dashed portion of the arrow leading into stage S212.

A stage S214 of flowchart 210 encompasses node messenger 126 returning request message RQM to simulated message generator 122 whereby simulated message generator 122 during a stage S216 of flowchart 210 reads simulation job queue 123 and simulation command queue 124 for a simulation reply job SRPJ and a simulation reply command SRPC responsive to request message RQM as shown in FIG. 10 to thereby simulate an execution of a node operation by simulated message generator 122.

A stage S218 of flowchart 210 encompasses simulated message generator 122 building a simulated reply message SRPM based on simulation reply job SRPJ and simulation reply command SRPC.

A stage S220 of flowchart 210 encompasses simulated message generator 122 calling node messenger 126 to place simulated reply message SRPM on reply message queue 184 and a stage S222 of flowchart 210 encompasses node messenger 126 placing simulated reply message SRPM on reply message queue 184 as shown in FIG. 10.

A stage S198 of flowchart 190 encompasses node messenger 182 pulling simulated reply message SRPM from reply message queue 184 in accordance with a polling scheme represented by a dashed portion of the arrow leading into stage S198.

A stage S200 of flowchart 190 encompasses node messenger 182 returning simulated reply message SRPM to requester process module 181 whereby requester process module 181 can process simulated reply message SRPM to thereby verify the contents of simulated reply message SRPM.

Referring to FIG. 10, upon termination of flowcharts 190 and 210, those having ordinary skill in the art will appreciate the generic, transparent and effective manner by which simulated reply message SRPM was generated by simulation data processing node 120 in lieu of an authentic execution of the subject node operation by simulation data processing node 120 whereby simulated reply message SRPM produces a verifiable outcome of the simulated execution of the subject node operation.

Referring to FIGS. 1-10, those having ordinary skill in the art will appreciate various benefits and advantages of the present invention, including, but not limited to, a generic, transparent and reconfigurable simulation testing of development code.

Still referring to FIGS. 1-10, examples of node operations include, but are not limited to, mounting and demounting of a tape and operability of a website.

Referring to FIG. 1, the term “processor” as used herein is broadly defined as one or more processing units of any type for performing all arithmetic and logical operations and decoding and executing all instructions related to facilitating an implementation by a data processing node of a synchronization method of the present invention. Additionally, the term “memory” as used herein is broadly defined as encompassing all storage space of any type within a data processing node.

Referring to FIG. 1, a domain of the present invention can have a X number of clusters and a Y number of nodes in each cluster or domain, where X≧0 and Y≧2. From the description herein of the present invention, those having ordinary skill in the art of simulation testing techniques will appreciate how to apply the inventive principles of the present invention to distributed data processing domains that are more or less complex than the 2 cluster/2 node per cluster configuration shown in FIG. 1.

Furthermore, those having ordinary skill in the art of simulation testing techniques may develop other embodiments of the present invention in view of the inventive principles of the present invention described herein. Thus, the terms and expression which have been employed in the foregoing specification are used herein as terms of description and not of limitations, and there is no intention in the use of such terms and expressions of excluding equivalents of the features shown and described or portions thereof, it being recognized that the scope of the present invention is defined and limited only by the claims which follow.

We claim:

1. In a distributed data processing domain including a plurality of data processing nodes, a method of operating a simulation data processing node as a participant in a simulation testing of a node operation, the method comprising:
a determination by the simulation data processing node of a simulation job and a simulation command responsive to the simulation testing of the node operation,
wherein the simulation job is indicative of at least one action to be performed by the simulation data processing node as a function of the simulation testing of the node operation, and
wherein the simulation command is indicative of a message format for a simulated message representative of simulation job; and
a building by the simulation data processing node of the simulated message based on the simulation job and the simulation command.

2. The method of claim 1, wherein the determination by the simulation data processing node of the simulation job and the simulation command responsive to the simulation testing of the node operation includes:
a simulation testing call by the simulation data processing node to simulate a request for an execution of the node operation by a target data processing node; and
a determination by the simulation data processing node of a simulation request job indicative of at least one request action to be performed by the simulation data processing node in a simulation of the request for the execution of the node operation by the target data processing node.

3. The method of claim 1, wherein the determination by the simulation data processing node of the simulation job and the simulation command responsive to the simulation testing of the node operation includes:
a simulation testing call by the simulation data processing node to simulate a request for an execution of the node operation by a target data processing node; and
a determination by the simulation data processing node of a simulation request command indicative of a request message format for a simulated request message representative of a least one request action to be performed by the simulation data processing node in simulating the request for the execution of the node operation by the target data processing node.

4. The method of claim 1, further comprising:
a communication of the simulated message from the simulation data processing node to a target data processing node as a simulated request message indicative of a simulated request by the simulation data processing node for the execution of the node operation by the target data processing node;
a communication of a reply message from the target data processing node to the simulation data processing node, wherein the reply message is indicative of an outcome of the execution of the node operation by the target data processing node;
a reading by the simulation data processing node of a simulation command queue to determine a reply message format responsive to the reply message; and
a verification by the simulation data processing node of a content of the reply message based on the reply message format.

5. The method of claim 1, wherein the determination by the simulation data processing node of the simulation job and the simulation command responsive to the simulation testing of the node operation includes:
a communication of a request message from a requester data processing node to the simulated data processing node, wherein the request message is indicative of a request for an execution of the node operation by the simulated data processing node; and
a determination by the simulation data processing node of a simulation reply job indicative of at least one reply action to be performed by the simulation data processing node in a simulation of the execution of the node operation.

6. The method of claim 1, wherein the determination by the simulation data processing node of the simulation job and the simulation command responsive to the simulation testing of the node operation includes:
a communication of a request message from a requester data processing node to the simulated data processing node, wherein the request message is indicative of a request for an execution of the node operation by the simulated data processing node; and
a determination by the simulation data processing node of a simulation reply command indicative of a reply message format for a simulated reply message representative of at least one reply action to be performed by the simulation data processing node in a simulation of the execution of the node operation.

7. The method of claim 1, further comprising:
a communication of the simulated message from the simulated data processing node to the requester data processing node as a simulated reply message indicative of an outcome of a simulated execution of the node operation by the simulation data processing node.

8. In a distributed data processing domain including a plurality of data processing nodes, a simulation data processing node comprising:
a processor; and
a memory operable with the processor to executed instructions for participating in a simulation testing of a node operation, the instructions being executable for:
a determination by the simulation data processing node of a simulation job and a simulation command responsive to the simulation testing of the node operation,
wherein the simulation job is indicative of at least one action to be performed by the simulation data processing node as a function of the simulation testing of the node operation, and
wherein the simulation command is indicative of a message format for a simulated message representative of the simulation job; and
a building by the simulation data processing node of the simulated message based on the simulation job and the simulation command.

9. The simulation data processing node of claim 8, wherein the determination by the simulation data processing node of the simulation job and the simulation command responsive to the simulation testing of the node operation includes:
a simulation testing call by the simulation data processing node to simulate a request for an execution of the node operation by a target data processing node; and
a determination by the simulation data processing node of a simulation request job indicative of at least one request action to be performed by the simulation data processing node in a simulation of the request for the execution of the node operation by the target data processing node.

10. The simulation data processing node of claim 8, wherein the determination by the simulation data processing node of the simulation job and the simulation command responsive to the simulation testing of the node operation includes:
a simulation testing call by the simulation data processing node to simulate a request for an execution of the node operation by a target data processing node; and
a determination by the simulation data processing node of a simulation request command indicative of a request message format for a simulated request message representative of a least one request action to be performed by the simulation data processing node in simulating the request for the execution of the node operation by the target data processing node.

11. The simulation data processing node of claim 8, wherein the instructions are further executed for:
a communication of the simulated message from the simulation data processing node to a target data processing node as a simulated request message indicative of a simulated request by the simulation data processing node for the execution of the node operation by the target data processing node;
a communication of a reply message from the target data processing node to the simulation data processing node, wherein the reply message is indicative of an outcome of the execution of the node operation by the target data processing node;
a reading by the simulation data processing node of a simulation command queue to determine a reply message format responsive to the reply message; and
a verification by the simulation data processing node of a content of the reply message based on the reply message format.

12. The simulation data processing node of claim 8, wherein the determination by the simulation data processing node of the simulation job and the simulation command responsive to the simulation testing of the node operation includes:
a communication of a request message from a requester data processing node to the simulated data processing node, wherein the request message is indicative of a request for an execution of the node operation by the simulated data processing node; and
a determination by the simulation data processing node of a simulation reply job indicative of at least one reply action to be performed by the simulation data processing node in a simulation of the execution of the node operation.

13. The simulation data processing node of claim 8, wherein the determination by the simulation data processing node of the simulation job and the simulation command responsive to the simulation testing of the node operation includes:
a communication of a request message from a requester data processing node to the simulated data processing node, wherein the request message is indicative of a request for an execution of the node operation by the simulated data processing node; and
a determination by the simulation data processing node of a simulation reply command indicative of a reply message format for a simulated reply message representative of at least one reply action to be performed by the simulation data processing node in a simulation of the execution of the node operation.

14. The simulation data processing node of claim 8, wherein the instructions are further executed for:
a communication of the simulated message from the simulated data processing node to the requester data processing node as a simulated reply message indicative of an outcome of a simulated execution of the node operation by the simulation data processing node.

15. In a distributed data processing domain including a plurality of data processing nodes, a simulation data processing node for participating in a simulation testing of a node operation, the simulation data processing node comprising:
a simulated message generator;
a simulation job queue including a simulation job indicative of at least one action to be performed by the simulated message generator as a function of the simulation testing of the node operation;
a simulation command queue including a simulation command indicative of a message format for a simulated message representative of simulation job; and
wherein the simulated message generator is operable to determine the simulation job and the simulation command as being responsive to the simulation testing of the node operation and to build the simulated message based on the simulation job and the simulation command.

16. The simulation data processing node of claim 15, wherein a determination by the simulated message generator of the simulation job and the simulation command responsive to the simulation testing of the node operation includes:
a simulation testing call by the simulated message generator to simulate a request for an execution of the node operation by a target data processing node; and
a reading by the simulated message generator of the simulation job queue based on the simulation testing call to determine a simulation request job indicative of at least one request action to be performed by the simulated message generator in a simulation of the request for the execution of the node operation by the target data processing node.

17. The simulation data processing node of claim 15, wherein a determination by the simulated message generator of the simulation job and the simulation command responsive to the simulation testing of the node operation includes:
a simulation testing call by the simulated message generator to simulate a request for an execution of the node operation by a target data processing node; and
a browsing by the simulated message generator of a simulation command queue based on the simulation testing call to determine a simulation request command indicative of a request message format for a simulated request message representative of a least one request action to be performed by the simulated message generator in simulating the request for the execution of the node operation by the target data processing node.

18. The simulation data processing node of claim 15, wherein the simulated message generator is further operable to:
participate in a communication of the simulated message from the simulation data processing node to a target data processing node as a simulated request message indicative of a simulated request by the simulated message generator for the execution of the node operation by the target data processing node;
participate in a communication of a reply message from the target data processing node to the simulation data processing node, wherein the reply message is indicative of an outcome of the execution of the node operation by the target data processing node;
read the simulation command queue to determine a reply message format responsive to the reply message; and
verify a content of the reply message based on the reply message format.

19. The simulation data processing node of claim 15, wherein a determination by the simulated message generator of the simulation job and the simulation command responsive to the simulation testing of the node operation includes:
a communication of a request message from a requester data processing node to the simulated data processing node, wherein the request message is indicative of a request for an execution of the node operation by the simulated data processing node; and
a reading by the simulated message generator of a simulation job queue based on the request message to determine a simulation reply job indicative of at least one reply action to be performed by the simulated message generator in a simulation of the execution of the node operation.

20. The simulation data processing node of claim 15, wherein a determination by the simulated message generator of the simulation job and the simulation command responsive to the simulation testing of the node operation includes:
a communication of a request message from a requester data processing node to the simulated data processing node, wherein the request message is indicative of a request for an execution of the node operation by the simulated data processing node; and
a browsing by the simulated message generator of a simulation command queue based on the request message to determine a simulation reply command indicative of a reply message format for a simulated reply message representative of at least one reply action to be performed by the simulated message generator in a simulation of the execution of the node operation.

21. The simulation data processing node of claim 15, wherein the simulated message generator is further operable to participate in a communication of the simulated message from the simulated data processing node to the requester data processing node as a simulated reply message indicative of an outcome of a simulated execution of the node operation by the simulated message generator.
